(19) United States
(12) Patent Application Publication
(10) Pub. No.: US 2022/0268912 A1
(43) Pub. Date: Aug. 25, 2022

(54) METHOD AND APPARATUS FOR LOCATING TARGET OBJECT

(71) Applicant: HUAWEI TECHNOLOGIES CO., LTD., Shenzhen (CN)

(72) Inventors: Meihong ZHANG, Shenzhen (CN); Xiangwen GUO, Chengdu (CN); Jiahui ZHANG, Chengdu (CN); Xiao HAN, Shenzhen (CN); Rui DU, Shenzhen (CN); Chenchen LIU, Shenzhen (CN); Li YAN, Chengdu (CN); Xuming FANG, Chengdu (CN)

(73) Assignee: HUAWEI TECHNOLOGIES CO., LTD., Shenzhen (CN)

(21) Appl. No.: 17/740,487

(22) Filed: May 10, 2022

Related U.S. Application Data
(63) Continuation of application No. PCT/CN2020/130119, filed on Nov. 19, 2020.

(30) Foreign Application Priority Data
Nov. 20, 2019 (CN) 201911140636.5

(51) Int. Cl. G01S 13/06

(52) U.S. Cl. CPC G01S 13/06; H04W 84/12

(57) ABSTRACT

A method for assisting in locating a target object, a method for locating a target object, and an apparatus. In an embodiment, the method for assisting in locating a target object is applied to a station (STA), and the method includes: receiving a wireless sensing sounding frame including radar measurement indication information from an access point (AP); sending an uplink data packet to the AP, recording a first sending moment, and performing radar measurement on a target object based on the radar measurement indication information to obtain a radar measurement result; receiving a downlink data packet from the AP, and recording a first receiving moment; and sending the first sending moment, the first receiving moment and the radar measurement result to the AP.

### CROSS-REFERENCE TO RELATED APPLICATIONS

This application is a continuation of International Application No. PCT/CN2020/130119, filed on Nov. 19, 2020, which claims priority to Chinese Patent Application No. 201911140636.5, filed on Nov. 20, 2019. The disclosures of the aforementioned applications are hereby incorporated by reference in their entireties.

### STATEMENT OF JOINT RESEARCH AGREEMENT

The subject matter and the claimed invention were made by or on the behalf of Southwest Jiaotong University and Huawei Technologies Co., Ltd., of Shenzhen, Guangdong Province, P.R. China, under a joint research agreement titled “Next generation 60 GHz WiFi MAC technology research project”. The joint research agreement was in effect on or before the claimed invention was made, and that the claimed invention was made as a result of activities undertaken within the scope of the joint research agreement.

### TECHNICAL FIELD

The embodiments relate to the communication field and a method and apparatus for locating a target object.

### BACKGROUND

Radar may be used to detect a target object, for example, detect one or more of a distance, a speed, and a direction angle (including an azimuth angle and a pitch angle) of the target object relative to the radar. The radar generally includes a transmit antenna and a receive antenna. The radar may transmit a radar signal (referred to as a transmitted wave) by using the transmit antenna, and receive, by using the receive antenna, a radar signal (referred to as a reflected wave) formed through reflecting the transmitted wave by the target object. Then, a radar measurement result may be obtained based on a change in the reflected wave relative to the transmitted wave, for example, the distance, the moving speed, and the direction angle of the target object relative to the radar, or other information for calculating any one of the distance, the moving speed, and the direction angle of the target object relative to the radar.

A wireless local area network (WLAN) has been widely deployed and applied as a local communication network with convenient access and a high data transmission rate. In a densely deployed WLAN, one access point (AP) is usually connected to a plurality of stations (STAs), and each STA may serve as a radar configured to detect a target object.

Generally, the AP may determine, from a plurality of STAs covered by the AP, a plurality of target STAs that can be configured to detect a target object under coordination of the AP. Then, the AP determines location information of the plurality of target STAs, and coordinate the plurality of target STAs to perform radar measurement on the target object. Next, the AP or a computing device connected to the AP may locate the target object based on the previously determined location information of the plurality of target STAs, and radar measurement results obtained when the plurality of target STAs separately perform radar measurement on the target object.

However, a STA in the WLAN generally has mobility. After the location information of the target STA is determined, the target STA may move. As a result, the location information of the target STA cannot accurately indicate an actual location when the target STA performs radar measurement, affecting a locating result of the target object.

### SUMMARY

Embodiments provide a method for assisting in locating a target object, a method for locating a target object, and an apparatus, to accurately locate a target object.

Embodiments provide at least the following solutions.

According to a first aspect, a method for assisting in locating a target object is provided, and is applied to a STA. The method includes:
receiving a wireless sensing sounding frame from an AP, where the wireless sensing sounding frame includes radar measurement indication information;
sending an uplink data packet to the AP, recording a first sending moment of the uplink data packet, and performing radar measurement on a target object based on the radar measurement indication information to obtain a radar measurement result;
receiving a downlink data packet from the AP, and recording a first receiving moment of the downlink data packet; and
sending the first sending moment, the first receiving moment and the radar measurement result to the AP.

In a possible implementation, the performing radar measurement on a target object based on the radar measurement indication information to obtain a radar measurement result includes:
sending a first radar signal based on the radar measurement indication information, and receiving a second radar signal based on the radar measurement indication information, where the second radar signal is formed through reflecting the first radar signal by the target object; and
determining the radar measurement result based on a first start moment at which the first radar signal is sent, a second start moment at which the second radar signal is received, the first radar signal, and the second radar signal.

In a possible implementation, a trigger dependent common information field in the wireless sensing sounding frame includes a radar information indication subfield, and the radar information indication subfield includes the radar measurement indication information.

In a possible implementation, one user information field in the wireless sensing sounding frame includes an application identification field and a trigger dependent user information field, where the application identification field includes an identifier of the STA, the trigger dependent user information field includes a radar information indication subfield, and the radar information indication subfield includes the radar measurement indication information.

In a possible implementation,
the radar information indication subfield includes a radar duration subfield and a resource control subfield; and
the radar measurement indication information includes radar duration and frequency band information, where the radar duration subfield includes the radar duration, and the resource control subfield includes the frequency band information.

In a possible implementation, the sending the first sending moment, the first receiving moment and the radar measurement result to the AP includes: sending a wireless sensing data frame to the AP in response to a wireless sensing report frame sent by the AP to the STA, where the wireless sensing data frame includes the first sending moment, the first receiving moment and the radar measurement result.

In a possible implementation,
a trigger dependent common information field in the wireless sensing report frame includes a feedback control subfield; and
the feedback control subfield includes at least a fine time measurement FTM feedback control subfield, the FTM feedback control subfield includes first indication information, and the first indication information is used to indicate the STA to send the wireless sensing data frame to the AP.

In a possible implementation,
a wireless sensing data action field in the wireless sensing data frame includes an FTM result element field; and
the first receiving moment and the first sending moment are included in the FTM result element field.

In a possible implementation, the wireless sensing data action field in the wireless sensing data frame further includes a wireless sensing data control field, and the wireless sensing data control field includes an FTM control subfield, where the FTM control subfield includes second indication information, and the second indication information is used to indicate the AP to obtain the first receiving moment and the first sending moment from the FTM result element field.

According to a second aspect, a method for locating a target object is provided, and is applied to an AP. The method is for each STA of a plurality of STAs, and includes:
sending a wireless sensing sounding frame to the STA, where the wireless sensing sounding frame includes radar measurement indication information;
receiving an uplink data packet from the STA, and recording a second receiving moment of the uplink data packet;
sending a downlink data packet to the STA, and recording a second sending moment of the downlink data packet;
receiving a first sending moment, a first receiving moment and a radar measurement result from the STA, where the first sending moment is a corresponding moment at which the STA sends the uplink data packet, the first receiving moment is a corresponding moment at which the STA receives the downlink data packet, and the radar measurement result is a radar measurement result obtained when the STA performs radar measurement on a target object based on the radar measurement indication information;
calculating a first distance between the STA and the AP based on the first sending moment, the first receiving moment, the second sending moment, and the second receiving moment; and
locating the target object based on the first distance and the radar measurement result corresponding to each of the plurality of STAs.

In a possible implementation, the sending a wireless sensing sounding frame to the STA includes: sending the wireless sensing sounding frame to the plurality of STAs in a multicast or broadcast manner, where a plurality of user information fields in the wireless sensing sounding frame are in a one-to-one correspondence with the plurality of STAs, the user information field includes an identifier of a corresponding STA and the radar measurement indication information used to indicate the corresponding STA to perform radar measurement, and the radar measurement indication information included in the plurality of user information fields each includes different frequency band information.

In a possible implementation, the user information field further includes channel information used to indicate the corresponding STA to send the uplink data packet, and the channel information included in each of the plurality of user information fields is different; and
the receiving an uplink data packet from the STA includes: receiving the uplink data packet from each of the plurality of STAs based on the channel information included in each user information field.

In a possible implementation, the sending a downlink data packet to the STA includes: sending the downlink data packet to the plurality of STAs in a multicast or broadcast manner.

According to a third aspect, an apparatus for assisting in locating a target object is provided, and is applied to a STA. The apparatus includes:
a transceiver unit, configured to: receive a wireless sensing sounding frame from an AP, where the wireless sensing sounding frame includes radar measurement indication information; send an uplink data packet to the AP; and receive a downlink data packet from the AP; and
a processing unit, configured to: record a first sending moment of the uplink data packet, record a first receiving moment of the downlink data packet, and perform radar measurement on a target object based on the radar measurement indication information to obtain a radar measurement result, where
the transceiver unit is further configured to send the first sending moment, the first receiving moment and the radar measurement result to the AP.

In a possible implementation,
the processing unit is configured to: trigger, based on the radar measurement indication information, the transceiver unit to send a first radar signal; and trigger, based on the radar measurement indication information, the transceiver unit to receive a second radar signal, where the second radar signal is formed through reflecting the first radar signal by the target object; and
the processing unit is configured to determine the radar measurement result based on a first start moment at which the transceiver unit sends the first radar signal, a second start moment at which the transceiver unit receives the second radar signal, the first radar signal, and the second radar signal.

In a possible implementation, a trigger dependent common information field in the wireless sensing sounding frame includes a radar information indication subfield, and the radar information indication subfield includes the radar measurement indication information.

In a possible implementation, one user information field in the wireless sensing sounding frame includes an application identification field and a trigger dependent user information field, where the application identification field includes an identifier of the STA, the trigger dependent user information field includes a radar information indication subfield, and the radar information indication subfield includes the radar measurement indication information.

In a possible implementation,
the radar information indication subfield includes a radar duration subfield and a resource control subfield; and
the radar measurement indication information includes radar duration and frequency band information, where the radar duration subfield includes the radar duration, and the resource control subfield includes the frequency band information.

In a possible implementation, the processing unit is configured to: in response to a wireless sensing report frame sent by the AP to the STA, trigger the transceiver unit to send a wireless sensing data frame to the AP, where the wireless sensing data frame includes the first sending moment, the first receiving moment and the radar measurement result.

In a possible implementation,
a trigger dependent common information field in the wireless sensing report frame includes a feedback control subfield; and
the feedback control subfield includes at least a fine time measurement FTM feedback control subfield, the FTM feedback control subfield includes first indication information, and the first indication information is used to indicate the STA to send the wireless sensing data frame to the AP.

In a possible implementation,
a wireless sensing data action field in the wireless sensing data frame includes an FTM result element field; and
the first receiving moment and the first sending moment are included in the FTM result element field.

In a possible implementation, the wireless sensing data action field in the wireless sensing data frame further includes a wireless sensing data control field, and the wireless sensing data control field includes an FTM control subfield, where the FTM control subfield includes second indication information, and the second indication information is used to indicate the AP to obtain the first receiving moment and the first sending moment from the FTM result element field.

According to a fourth aspect, an apparatus for locating a target object is provided, and is applied to an AP. The apparatus includes:
a transceiver unit, configured to: for each STA of a plurality of STAs, send a wireless sensing sounding frame to the STA, where the wireless sensing sounding frame includes radar measurement indication information; receive an uplink data packet from the STA; send a downlink data packet to the STA; and receive a first sending moment, a first receiving moment and a radar measurement result from the STA, where the first sending moment is a corresponding moment at which the STA sends the uplink data packet, the first receiving moment is a corresponding moment at which the STA receives the downlink data packet, and the radar measurement result is a radar measurement result obtained when the STA performs radar measurement on a target object based on the radar measurement indication information; and
a processing unit, configured to: record a second receiving moment of the uplink data packet; record a second sending moment of the downlink data packet; calculate a first distance between the STA and the AP based on the first sending moment, the first receiving moment, the second sending moment, and the second receiving moment; and locate the target object based on the first distance and the radar measurement result corresponding to each of the plurality of STAs.

In a possible implementation, the processing unit is configured to trigger the transceiver unit to send the wireless sensing sounding frame to the plurality of STAs in a multicast or broadcast manner, where a plurality of user information fields in the wireless sensing sounding frame are in a one-to-one correspondence with the plurality of STAs, the user information field includes an identifier of a corresponding STA and the radar measurement indication information used to indicate the corresponding STA to perform radar measurement, and the radar measurement indication information included in the plurality of user information fields each includes different frequency band information.

In a possible implementation,
the user information field further includes channel information used to indicate the corresponding STA to send the uplink data packet, and the channel information included in each of the plurality of user information fields is different; and
the processing unit is configured to trigger, based on the channel information included in each user information field, the transceiver unit to receive the uplink data packet from each of the plurality of STAs.

In a possible implementation, the processing unit is configured to trigger the transceiver unit to send the downlink data packet to the plurality of STAs in a multicast or broadcast manner.

According to a fifth aspect, a computer-readable storage medium is provided, and is configured to store instructions. When the instructions are executed by a processor of a STA, the STA is enabled to implement the method according to any one of the first aspect.

According to a sixth aspect, a computer-readable storage medium is provided, and is configured to store instructions. When the instructions are executed by a processor of an AP, the AP is enabled to implement the method according to any one of the second aspect.

According to a seventh aspect, a STA is provided, and includes a memory and a processor. The memory stores executable code, and when the processor executes the executable code, the method according to any one of the first aspect is implemented.

According to an eighth aspect, an AP is provided, and includes a memory and a processor. The memory stores executable code, and when the processor executes the executable code, the method according to any one of the second aspect is implemented.

According to a ninth aspect, a computer program product is provided. The computer program product includes computer program code, and when the computer program code is run on a computer, the computer is enabled to perform the method according to any one of the first aspect.

According to a tenth aspect, a computer program product is provided. The computer program product includes computer program code, and when the computer program code is run on a computer, the computer is enabled to perform the method according to any one of the second aspect.

According to an eleventh aspect, a communication apparatus is provided, and the communication apparatus has functions of the STA in the foregoing aspects. The functions of the STA may be implemented by using hardware or may be implemented by using hardware executing corresponding software. The hardware or the software includes one or more units corresponding to the foregoing functions.

According to a twelfth aspect, a communication apparatus is provided, and the communication apparatus has functions of the AP in the foregoing aspects. The functions of the AP may be implemented by using hardware or may be implemented by using hardware executing corresponding software. The hardware or the software includes one or more units corresponding to the foregoing functions.

According to a thirteenth aspect, a communication apparatus is provided. The communication apparatus may be the STA in the foregoing aspects, or may be a chip disposed in the STA. The communication apparatus includes a memory, a communication interface, and a processor. The memory is configured to store a computer program or instructions. The processor is coupled to the memory and the communication interface. When the processor executes the computer program or the instructions, the communication apparatus is enabled to perform the method according to any one of the first aspect.

According to a fourteenth aspect, a communication apparatus is provided. The communication apparatus may be the AP in the foregoing aspects, or may be a chip disposed in the AP. The communication apparatus includes a memory, a communication interface, and a processor. The memory is configured to store a computer program or instructions. The processor is coupled to the memory and the communication interface. When the processor executes the computer program or the instructions, the communication apparatus is enabled to perform the method according to any one of the second aspect.

According to fifteenth aspect, a chip system is provided. The chip system includes a processor, configured to implement functions of the STA in the aspects, for example, receive or process data and/or information in the method according to the first aspect. The chip system may further include a memory. The memory is configured to store program instructions and/or data. The chip system may include a chip or may include a chip and another discrete device.

According to sixteenth aspect, a chip system is provided. The chip system includes a processor, configured to implement functions of the AP in the aspects, for example, receive or process data and/or information in the method according to the second aspect. The chip system may further include a memory. The memory is configured to store program instructions and/or data. The chip system may include a chip or may include a chip and another discrete device.

According to the solutions, a STA concurrently performs radar measurement on a target object in a process in which an AP performs fine time measurement (FTM, fine time measurement) on the STA, and an FTM result of the STA can accurately indicate an actual location of the STA when the STA performs radar measurement on the target object. Correspondingly, the AP may accurately locate the target object based on radar measurement results and FTM results of a plurality of STAs.

### BRIEF DESCRIPTION OF DRAWINGS

The following briefly describes the accompanying drawings used to describe embodiments or the conventional technology.

FIG. 1 is a schematic diagram of a frequency change relationship between a first radar signal and a second radar signal according to an embodiment;

FIG. 2 is a schematic diagram of an application scenario to which a solution according to an embodiment is applicable;

FIG. 3 is a schematic diagram of a radar coordinate system according to an embodiment;

FIG. 4 shows an example of measuring an angle of arrival of an electromagnetic wave by using a phase-based angle estimation method according to an embodiment;

FIG. 5 is a flowchart of a method for assisting in locating a target object according to an embodiment;

FIG. 6 is a schematic diagram of a structure of a wireless sensing sounding frame according to an embodiment;

FIG. 7 is a schematic diagram of a structure of another wireless sensing sounding frame according to an embodiment;

FIG. 8 is a schematic diagram of a structure of a wireless sensing report frame according to an embodiment;

FIG. 9 is a schematic diagram of a structure of a wireless sensing data frame according to an embodiment;

FIG. 10 is a flowchart of a method for locating a target object according to an embodiment;

FIG. 11 is a first schematic diagram of an information exchange process between an AP and a plurality of STAs according to an embodiment;

FIG. 12 is a second schematic diagram of an information exchange process between an AP and a plurality of STAs according to an embodiment;

FIG. 13 is a third schematic diagram of an information exchange process between an AP and a plurality of STAs according to an embodiment;

FIG. 14 is a schematic diagram of a structure of an apparatus for assisting in locating a target object according to an embodiment; and

FIG. 15 is a schematic diagram of a structure of an apparatus for locating a target object according to an embodiment.

### DETAILED DESCRIPTION OF THE EMBODIMENTS

The following describes solutions in the embodiments with reference to the accompanying drawings.

In embodiments, a target object includes but is not limited to a person or people, for example, may further include physical devices in various forms.

In embodiments, an AP is a network device configured to connect a STA to a wired network. A network coverage area of a single AP may generally reach tens of meters. Communication between the AP and STAs within the coverage area of the AP is generally performed based on the IEEE802.11 protocol.

In embodiments, the STA may be a wireless communication device having a transmit antenna and a receive antenna, and the wireless communication device generally has mobility. The wireless communication device may also be referred to as a mobile device (MD), user equipment (UE), a terminal , a mobile station (MS), or a mobile terminal (MT). The STA may include but is not limited to various forms of a mobile phone (or referred to as a “cellular” phone), a notebook computer, a tablet computer, and a desktop computer having a wireless communication module. For example, the STA may further include various forms of internet of things terminals and various portable, pocket-sized, hand-held, computer built-in or vehicle-mounted mobile devices.

It may be understood that a radar may be classified into a monostatic radar and a multistatic radar depending on whether a transmit antenna and a receive antenna of the radar have same address information. Correspondingly, if one radar has both a transmit antenna and a receive antenna, the radar may not only serve as a monostatic radar but may also cooperate with another radar to serve as a radar signal transmit end of a multistatic radar or serve as a radar signal receive end of the multistatic radar.

In the embodiments, a wireless communication device that serves as a STA generally has both a transmit antenna and a receive antenna. In this case, one STA may serve as a monostatic radar under coordination of the AP, or may serve as a radar signal transmit end or a radar signal receive end of a multistatic radar under coordination of the AP.

When the STA serves as a monostatic radar, the STA may first send a first radar signal based on radar measurement indication information obtained by the STA and receive a second radar signal based on the radar measurement indication information, where the second radar signal is formed through reflecting the first radar signal by a target object. Then, the STA determines a radar measurement result based on a first start moment at which the first radar signal is sent, a second start moment at which the second radar signal is received, the first radar signal, and the second radar signal.

The first radar signal sent by the STA may be a common continuous wave sent by the STA based on radar duration and frequency band information, may be a frequency-modulated continuous wave sent by the STA based on the radar duration and the frequency band information, or may be a pulse signal sent by the STA based on the radar duration and the frequency band information.

By using an example in which a first radar signal sent by one STA is a frequency-modulated continuous wave, the following describes a process in which the STA performs radar measurement on a target object to obtain a radar measurement result.

As shown in FIG. 1, in radar measurement indication information obtained by a STA and used to indicate the STA to perform radar measurement on a target object, radar duration is 2T, and frequency band information limits a frequency band of a first radar signal Si sent by the STA to be within a frequency band f3 to f4.

First, the STA may send the first radar signal S1 whose period is T and whose modulation bandwidth B is (f2-f1) on a frequency-modulated band f1 to f2 at a first start moment T1 and stop sending the first radar signal S1 at T3. A time difference between T3 and T1 is the radar duration 2 T, and the frequency-modulated band f1 to f2 is within the frequency band f3 to f4.

Then, the STA may start receiving a second radar signal S2 or S3 on the frequency band f3 to f4 at a second start moment T2 and stop receiving the second radar signal S2 or S3 on the frequency band f3 to f4 after T4. A time difference between T4 and T2 is the radar duration 2T.

It may be understood that, if the STA and the target object are relatively static in a time period T1 to T4, the STA may receive, on the frequency-modulated band f1 to f2, the second radar signal S2 whose waveform is the same as that of the first radar signal S1. If the STA and the target object are not relatively static in the time period T1 to T4, that is, if the STA and/or the target object move in the time period T1 to T4, the second radar signal received by the STA may include a Doppler frequency fd generated when the STA and/or the target object move, and the STA may receive the second radar signal S3 including the Doppler frequency fd.

Further, the STA may obtain a radar measurement result of the STA based on the first start moment T1 at which the STA sends the first radar signal, the second start moment T2 at which the STA receives the second radar signal, the first radar signal S1, and the second radar signal S2/S3.

The STA may perform sampling processing on S1 and S2/S3 based on T1 and T2. Further, the STA or an AP performs a fast Fourier transformation (FFT) on a first radar signal S1 and a second radar signal S2 that are obtained through sampling processing, to obtain a distance between the target object and the STA. A direction angle and a radial moving speed of the target object relative to the STA may be further obtained. Correspondingly, the radar measurement result obtained by the STA includes but is not limited to the following three forms.

Before FFT: The STA may perform frequency mixing on the first radar signal S1 and the second radar signal S2/S3 based on the first start moment T1 at which the STA sends the first radar signal and the second start moment T2 at which the STA receives the second radar signal, to obtain an intermediate frequency signal. An analog-to-digital converter (ADC) converts the intermediate frequency signal to a digital signal, and samples the digital signal to obtain a sampled digital signal. The sampled digital signal may include a sampling frequency, a quantity of sampling points, and a sampling value corresponding to each sampling point. The STA may feedback the sampled digital signal as the radar measurement result of the STA to the AP.

FFT info: The STA may further perform N-point FFT on the sampled digital signal to obtain a frequency domain graph corresponding to the sampled digital signal. In the frequency domain graph, each point (a horizontal axis) corresponds to a frequency point, and a modulus value (a vertical axis) of the point is an amplitude characteristic at the frequency point. The STA may feedback the frequency domain graph as the radar measurement result of the STA to the AP.

FFT result: The STA may further perform range-FFT on the frequency domain graph to obtain the distance between the target object and the STA, and the STA may feedback the distance between the target object and the STA as the radar measurement result of the STA to the AP. Optionally, the STA may further perform Doppler-FFT on the frequency domain graph to obtain the radial moving speed of the target object relative to the STA, add the radial moving speed to the radar measurement result of the STA, and feedback a radar measurement result to the AP. Optionally, the STA may further perform angle-FFT on the frequency domain graph to obtain the direction angle of the target object relative to the STA, add the direction angle to the radar measurement result of the STA, and feedback a radar measurement result to the AP.

In an example, the STA or the AP may calculate the distance between the target object and the STA according to the following formula 1 or formula 2:

$$\begin{matrix}R = ( T 2 - T 1 ) \times c / 2 & ( 1 ) \\ R = \frac{c \times T}{4 B} \times f 0 & ( 2 )\end{matrix}$$

R represents the distance between the target object and the STA, T2 represents the second start moment, T1 represents the first start moment, c represents the speed of light, T represents a frequency-modulated period of the first radar signal sent by the STA, B represents the modulation bandwidth of the first radar signal sent by the STA, and f0 represents a frequency of the intermediate frequency signal.

It should be noted that, when the target object and/or the STA move, the frequency f0 of the intermediate frequency signal may be calculated according to the following formula 3:

$$f 0 = \frac{( fa + fb )}{2} \qquad ( 3 )$$

fa represents a difference frequency of the second radar signal relative to the first radar signal in a forward frequency-modulated phase, and fb represents a difference frequency of the second radar signal relative to the first radar signal in a negative frequency-modulated phase.

In an example, the STA or the AP may calculate the radial moving speed of the target object relative to the STA according to the following formula 4:

$${V}_{R} = \frac{c}{2 {f}_{x}} \times \frac{( fb - fa )}{2} \qquad ( 4 )$$

V_{R} represents the radial moving speed of the target object relative to the STA, and fₓ represents a center frequency of the first radar signal sent by the STA.

It should be noted that, when a first radar signal sent by one STA is a common continuous wave, the STA or the AP may first calculate the distance between the target object and the STA according to the foregoing formula 1, and calculate the radial moving speed V_{R} of the target object relative to the STA according to the following formula 5:

$${V}_{R} = \frac{( {f}_{m} - {f}_{n} ) \times c}{{f}_{n}} \qquad ( 5 )$$

fₘ represents a frequency of the second radar signal received by the STA, and fₙ represents a frequency of the first radar signal sent by the STA.

It should be noted that, for V_{R} calculated in the foregoing manners, a value of V_{R} is a positive number, indicating that the target object moves in a direction close to the STA, and the value of V_{R} is a negative number, indicating that the target object moves in a direction away from the STA.

When the STA serves as a radar signal transmit end of a multistatic radar, the STA may first send a first radar signal based on radar measurement indication information used to indicate the STA to perform radar measurement, and use a first start moment at which the STA sends the first radar signal and information about the first radar signal such as a period and a frequency-modulated band as a radar measurement result. The first radar signal is used to form a second radar signal through reflection by a target object, and another STA that corresponds to the STA and that serves as a radar signal receive end of the multistatic radar may receive the second radar signal.

When the STA serves as a radar signal receive end of a multistatic radar, the STA may first receive a second radar signal based on radar measurement indication information used to indicate the STA to perform radar measurement and use a second start moment at which the STA receives the second radar signal and the second radar signal as a radar measurement result. The second radar signal is formed through reflecting a first radar signal by a target object, and the first radar signal is sent by another STA that corresponds to the STA and that serves as a radar signal transmit end of the multistatic radar.

It may be understood that the AP may perform comprehensive processing on radar measurement results separately sent by groups of STAs corresponding to each other, to accurately locate the target object.

In the embodiments, locating the target object includes but is not limited to determining location information of the target object in a coordinate system. For example, locating the target object may further include determining a distance between the target object and the AP in the coordinate system, and determining an azimuth angle, a pitch angle, a radial moving speed, and the like of the target object relative to the AP in the coordinate system.

In the embodiments, the coordinate system includes but is not limited to a geographic coordinate system, for example, may alternatively be a map coordinate system constructed based on an actual service requirement.

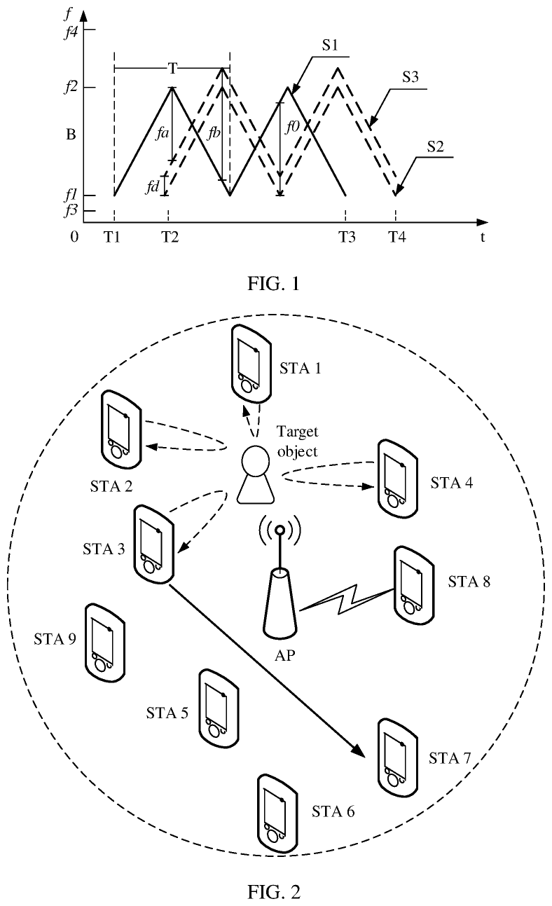

FIG. 2 is a schematic diagram of an application scenario to which a solution according to an embodiment is applicable. As shown in FIG. 2, in a densely deployed WLAN, there may be a plurality of STAs in a coverage area of an AP, and the AP may establish connections to the plurality of STAs in the coverage area of the AP for communication. For example, the AP may simultaneously establish connections to a STA 1 to a STA 9. The AP may poll the STAs that are located in the coverage area of the AP and that have established a connection to the AP, to determine a target STA that can perform radar measurement on a target object as a radar under coordination of the AP. Then, the AP may further coordinate a plurality of target STAs to separately perform radar measurement on the target object and locate the target object based on radar measurement results of and location information of the plurality of target STAs in a coordinate system.

For example, when the AP needs to coordinate the plurality of STAs to separately perform radar measurement on the target object, the AP may separately send a wireless sensing poll (WiFi sensing poll) frame to the STA 1 to the STA 9. If the STA 1, a STA 2, a STA 3, and a STA 4 determine, automatically or triggered by a user when receiving the WiFi sensing poll frame from the AP, that they can perform radar measurement on the target object as radars, the STA 1, they may send clear to send to self frames to the AP. Correspondingly, if the AP receives the clear to send to self frames from the STA 1, the STA 2, the STA 3, and the STA 4, but does not receive clear to send to self frames from a STA 5 to the STA 9, the AP may determine the STA 1, the STA 2, the STA 3, and the STA 4 as STAs that can perform radar measurement on the target object as radars under coordination of the AP.

For example, the STA 1, the STA 2, the STA 3, and the STA 4 each serve as a monostatic radar including a receive antenna and a transmit antenna. For each STA of the STA 1, the STA 2, the STA 3, and the STA 4, as described above, the STA may send, under coordination of the AP, a radar signal (referred to as a transmitted wave) used to detect a target object by using the transmit antenna of the STA. The transmitted wave may be reflected by the target object, and a radar signal formed by reflecting the transmitted wave by the target object may be referred to as a reflected wave. The STA may receive the reflected wave by using the receive antenna of the STA and obtain a radar measurement result based on a change in the reflected wave relative to the transmitted wave. Then, the AP or another computing device connected to the AP may locate the target object based on radar measurement results and location information of the STA 1, the STA 2, the STA 3, and the STA 4 in a coordinate system.

In the conventional technology, after determining location information of a plurality of STAs, an AP triggers the plurality of STAs to separately perform radar measurement on a target object. Due to mobility of the STA, previously determined location information of the STA cannot accurately indicate an actual location of the STA when the STA performs radar measurement on the target object. This affects accuracy of a locating result obtained subsequently when the target object is located. For example, the application scenario shown in FIG. 2 is still used as an example. After determining of the location information of the STA 3 is completed, the STA 3 may move from a location of the STA 3 to another location (for example, a location of a STA 7) before the STA 3 performs radar measurement on the target object and/or in a process in which the STA 3 performs radar measurement on the target object. As a result, the previously determined location information of the STA 3 cannot accurately indicate an actual location of the STA 3 when the STA 3 performs radar measurement on the target object.

In view of this, embodiments provide at least one method for assisting in locating a target object, a method for locating a target object, and an apparatus. A STA concurrently performs radar measurement on a target object in a process in which an AP performs FTM on the STA, and an FTM result of the STA can accurately indicate an actual location of the STA when the STA performs radar measurement on the target object. Correspondingly, the AP may accurately locate the target object based on radar measurement results and FTM results of a plurality of STAs.

It may be understood that the AP may separately perform FTM on the plurality of STAs based on the IEEE802.11az protocol. In a process in which an AP performs FTM on one STA, the AP may receive an uplink data packet from the STA, and send a downlink data packet to the STA. An FTM result of the STA may include at least: a first sending moment t1 at which the STA sends the uplink data packet to the AP, a first receiving moment t4 at which the STA receives the downlink data packet from the AP, a second receiving moment t2 at which the AP receives the uplink data packet from the STA, and a second sending moment t3 at which the AP sends the downlink data packet to the STA. Correspondingly, the AP may calculate, based on the FTM result of the STA, that a round trip time (RTT, round trip time) defined in IEEE802.11az is [(t2−t1)+(t4−t3)], and that a distance between the STA and the AP is RTT×c/2, where c represents the speed of light, and a value of c is usually 3×10⁸ m/s.

It may be understood that, if the STA concurrently performs radar measurement on the target object in the process in which the AP performs FTM on the STA, the distance between the STA and the AP determined based on the FTM result of the STA can accurately indicate an actual distance between the STA and the AP when the STA performs radar measurement on the target object. Correspondingly, location information of the STA determined based on the distance between the STA and the AP can accurately indicate an actual location of the STA when the STA performs radar measurement on the target object. This helps accurately locate the target object.

In a possible implementation, the AP may send an FTM request to one STA before performing FTM on the STA. The FTM request may carry indication information, and the indication information is used to indicate the STA to measure an angle of arrival (including an azimuth angle and a pitch angle) of an electromagnetic wave sent by the AP to the STA. When the STA can measure the angle of arrival of the electromagnetic wave sent by the AP to the STA, the STA may send the measured angle of arrival to the AP. The AP may determine the location information of the STA based on location information of the AP in a coordinate system, the angle of arrival measured by the STA, and the distance between the STA and the AP when the STA performs radar measurement on a target object, to locate the STA.

In another possible implementation, the STA may not have a capability of measuring an angle of arrival of an electromagnetic wave sent by the AP to the STA, but the AP can measure an angle of arrival of an electromagnetic wave from the STA. Correspondingly, after the AP completes measuring an angle of arrival (including an azimuth angle and a pitch angle) of an electromagnetic wave from one STA, the AP may determine location information of the STA based on location information of the AP in a coordinate system, the angle of arrival of the electromagnetic wave from the STA, and the distance between the STA and the AP when the STA performs radar measurement on a target object, to locate the STA.

In this embodiment, an AP may measure an angle of arrival of an electromagnetic wave from a STA by using at least one or a combination of an amplitude-based angle estimation method and a phase-based angle estimation method. In this way, the AP determines location information of the STA based on location information of the AP in a coordinate system, the angle of arrival of the electromagnetic wave from the STA, and a distance between the STA and the AP when the STA performs radar measurement on a target object.

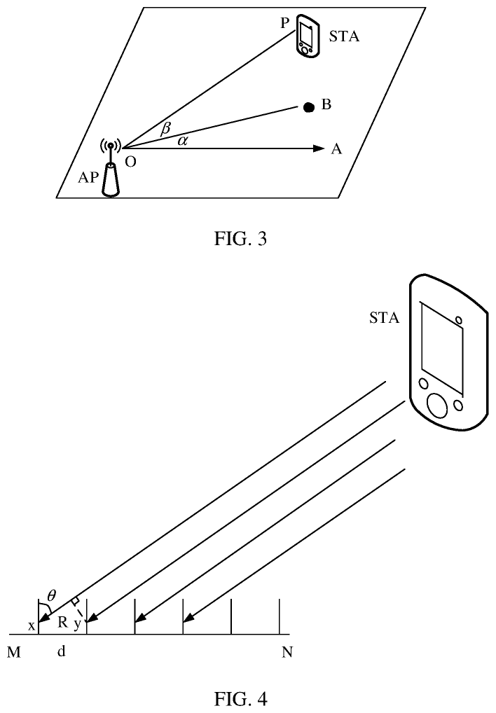

With reference to a radar coordinate system shown in FIG. 3 and an example of the phase-based angle estimation method shown in FIG. 4, the following describes an example in which the AP measures the angle of arrival of the electromagnetic wave from the STA by using phase-based angle estimation method.

As shown in FIG. 3, that the AP measures the angle of arrival of the electromagnetic wave from the STA includes measuring an azimuth angle α and a pitch angle β of the electromagnetic wave. OP represents a distance between the AP and the STA, OB represents a projection of OP on a horizontal plane, OA represents a reference direction (for example, a due north direction on the horizontal plane) preset based on a geographic coordinate system, the azimuth angle α is an included angle between OA and OB in a horizontal direction, the pitch angle β is an included angle between OB and OP on a vertical plane perpendicular to the horizontal plane, and the pitch angle β may also be referred to as a tilt angle, an angle of site, or an elevation angle.

As shown in FIG. 4, the AP may include a plurality of T-shaped receive antennas, and the plurality of T-shaped receive antennas may form a receive antenna array in the AP in an array manner shown in FIG. 4. For ease of description, here uses an example in which a direction of MN in the receive antenna array of the AP is parallel to a preset reference direction in a radar coordinate system, and a projection of the STA on the horizontal plane is located on an extension line of MN. A distance between the STA and the AP is usually far greater than a distance between two adjacent receive antennas in the AP, and electromagnetic waves reaching two adjacent receive antennas x and y included in the AP are approximately plane waves. In addition, because there is a distance between x and y, there is a wave path difference R between the electromagnetic waves received by x and y. Therefore, the electromagnetic waves received by x and y generate a phase difference φ due to the wave path difference R. A relationship between the phase difference φ and the wave path difference R satisfies the following formula 6:

$$φ = \frac{2 π}{λ} R = \frac{2 π}{λ} d sin θ \qquad ( 6 )$$

λ represents wavelengths of the electromagnetic waves received by x and y, θ represents included angles between x and the electromagnetic wave received by x and between y and the electromagnetic wave received by y, and d represents a distance between x and y in a horizontal direction. Phase comparison may be performed on the electromagnetic waves received by x and y by using dedicated software and/or hardware (for example, a phase meter), to obtain the phase difference φ.

Correspondingly, the AP may further determine the pitch angle β of the electromagnetic wave from the STA based on the included angle θ between the receive antenna and the electromagnetic wave received by the receive antenna. Herein, it may be determined that the pitch angle β of the electromagnetic wave from the STA is (90 degrees−θ).

In this embodiment, the azimuth angle α of the electromagnetic wave from the STA may be determined by using a method similar to that for measuring the pitch angle β.

It should be noted that the electromagnetic wave used to measure the angle of arrival in the foregoing example includes but is not limited to an electromagnetic wave corresponding to an uplink data packet received by the AP from the STA. For example, the electromagnetic wave may be an electromagnetic wave corresponding to a wireless sensing data (WiFi sensing data) frame sent by the STA to the AP, or an electromagnetic wave corresponding to a location measurement report (LMR) frame sent by the STA to the AP.

It should be noted that, when the STA can measure the angle of arrival of the electromagnetic wave sent by the AP to the STA, the STA may report, to the AP by using an LMR frame, the angle of arrival measured by the STA. The angle of arrival may include an angle of arrival of an electromagnetic wave corresponding to a downlink data packet sent by the AP to the STA.

Location information of each STA obtained in the foregoing manners is obtained through calculation based on a distance between each STA and the AP in a process in which each STA performs radar measurement on the target object. The distance between each STA and the AP is obtained through calculation based on an FTM result obtained through FTM by the AP on each STA. This can accurately indicate an actual distance between each STA and the AP when each STA performs radar measurement on the target object. Correspondingly, the location information of each STA obtained in the foregoing manners can accurately indicate an actual location of each STA when each STA performs radar measurement on the target object. The AP or a computing device connected to the AP may accurately locate the target object based on radar measurement results and location information of the plurality of STAs.

It may be understood that, the STA may move at a small moving speed in a process of performing radar measurement on the target object. An example in which a first radar signal sent by one STA is a frequency-modulated continuous wave is still used. In a possible implementation, an AP may further receive the first radar signal sent by the STA and calculate a radial moving speed of the STA relative to the AP based on the first radar signal. Radial moving speeds of a plurality of STAs separately relative to the AP may be used to assist the AP in locating a target object based on a first distance and a radar measurement result that are corresponding to each of the plurality of STAs.

In this embodiment, the radial moving speed of the STA relative to the AP may be determined by using a method similar to the foregoing method for measuring a radial moving speed of the target object relative to the STA.

In an example, the radial moving speed of the STA relative to the AP may be used at least to correct the first distance of the STA relative to the AP.

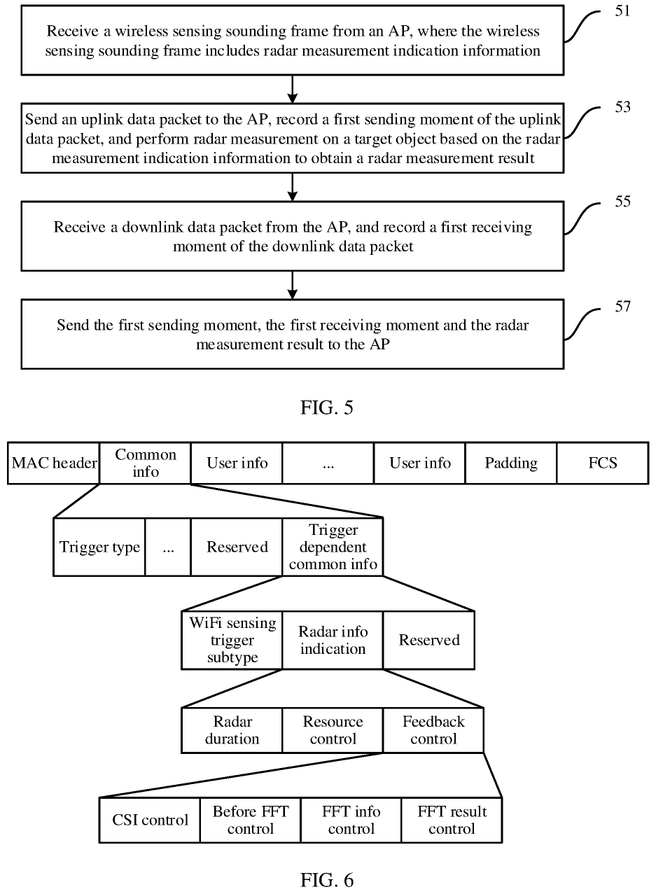

The following describes in detail steps that need to be performed by the AP and the STA in a process of locating the target object. As shown in FIG. 5, an embodiment provides a method for assisting in locating a target object. The method is applied to a STA, and the STA may perform at least the following step 51 to step 57.

Step 51: Receive a wireless sensing sounding frame from an AP, where the wireless sensing sounding frame includes radar measurement indication information.

In this embodiment, the radar measurement indication information includes but is not limited to radar duration and frequency band information.

In a possible implementation, the wireless sensing sounding frame may include one piece of radar measurement indication information, and the STA may obtain the radar measurement indication information from the wireless sensing sounding frame.

In an example, the wireless sensing sounding frame may have a structure shown in FIG. 6. As shown in FIG. 6, the wireless sensing sounding frame may include a media access control (MAC) header field, a common information (common info) field, one or more user information (user info) fields, a padding field, and a frame check sequence (FCS) field. The common info field may include at least a trigger type field, a reserved field, and a trigger dependent common information (trigger dependent common info) field. The trigger dependent common info field may include a wireless sensing trigger subtype (WiFi sensing trigger subtype) subfield, a radar information indication (radar info indication) subfield, and a reserved subfield. The radar info indication subfield may include a radar duration subfield and a resource control subfield. The radar duration subfield may store radar duration included in the radar measurement indication information used to indicate the STA to perform radar measurement, and the resource control subfield may store frequency band information included in the radar measurement indication information used to indicate the STA to perform radar measurement.

It should be understood that, when an AP communicates with a STA based on the IEEE802.11 protocol, a trigger frame sent by the AP to the STA and used to trigger the STA to perform a service generally includes a MAC header field, a common info field, one or more user info fields, a padding field, and an FCS field as shown in FIG. 6. The STA may determine a trigger type of the trigger frame based on a value of a trigger type field included in the common info field in the trigger frame. For example, the trigger frame from the AP is used to indicate the STA to perform a service procedure related to a trigger type “wireless sensing (WiFi sensing)”, and the value of the trigger type field may be 9.

In this embodiment, the trigger frame from the AP used to trigger the STA to perform the service procedure related to “WiFi sensing” includes but is not limited to a wireless sensing sounding frame. For example, the trigger frame may further include a WiFi sensing poll frame and a wireless sensing report (WiFi sensing report) frame.

In an example, the AP may indicate, based on a value of a WiFi sensing trigger subtype subfield, the STA to perform various service procedures related to the trigger type “WiFi sensing”. Three reserved values may be selected from reserved values of the “WiFi sensing trigger subtype” subfield of the trigger type “WiFi sensing”. The selected three reserved values are used to indicate the STA to perform a service procedure corresponding to each of a WiFi sensing poll frame, a WiFi sensing sounding frame, and a WiFi sensing report frame. For example, refer to the following Table 1.

TABLE 1

| WiFi sensing trigger | |
|---|---|
| subtype field value | Meaning |
| 1 | Report |
| 2 | Poll |
| 3 | Sounding |

As shown in Table 1, the reserved values of the “WiFi sensing trigger subtype” subfield of the trigger type “WiFi sensing” include “1”, “2”, and “3”. When the STA receives a trigger frame from the AP, the STA may first obtain a value of a trigger type field included in a common info field in the trigger frame. If the value of the trigger type field indicates that the trigger frame is used to trigger the STA to perform a service procedure related to the trigger type “WiFi sensing”, Then, the STA further obtains a value of a WiFi sensing trigger subtype subfield included in a trigger dependent user info field in the trigger frame, and performs various service procedures related to the trigger type “WiFi sensing” based on the value of the WiFi sensing trigger subtype subfield. For example, if the value of the WiFi sensing trigger subtype subfield is 2, indicating that the trigger frame is a WiFi sensing poll frame, the STA may respond to the WiFi sensing poll frame according to a corresponding service procedure. If the value of the WiFi sensing trigger subtype subfield is 3, indicating that the trigger frame is a WiFi sensing sounding frame, the STA may respond to the WiFi sensing sounding frame according to a corresponding service procedure. If the value of the WiFi sensing trigger subtype subfield is 1, indicating that the trigger frame is a WiFi sensing report frame, the STA may respond to the WiFi sensing report frame according to a corresponding service procedure.

In another possible implementation, the wireless sensing sounding frame may include a plurality pieces of radar measurement indication information, and the STA may obtain, from the wireless sensing sounding frame based on an identifier of the STA, the radar measurement indication information associated with the identifier of the STA.

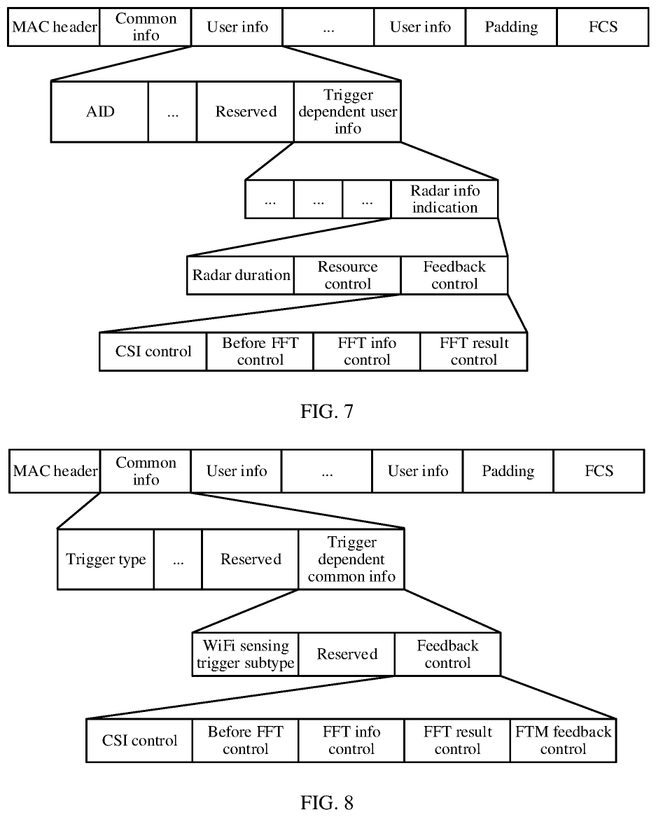

In an example, the wireless sensing sounding frame may have a structure shown in FIG. 7. As shown in FIG. 7, the wireless sensing sounding frame may include a MAC header field, a common info field, one or more user info fields, a padding field, and an FCS field. For one user info field, the user info field may include at least an application identification (AID) field, a reserved field, and a trigger dependent user information (trigger dependent user info) field. The AID field is used to store an identifier of a STA, and the trigger dependent user info field may include at least a radar info indication subfield. The radar info indication subfield may include a radar duration subfield and a resource control subfield. The radar duration subfield may store radar duration included in the radar measurement indication information used to indicate the STA to perform radar measurement, and the resource control subfield may store frequency band information included in the radar measurement indication information used to indicate the STA to perform radar measurement.

Correspondingly, when receiving the wireless sensing sounding frame from the AP, the STA may first query, based on the identifier of the STA, an AID field included in each of one or more user info fields in the wireless sensing sounding frame, to determine a target user info field in which the AID field including the identifier of the STA is located. Then, the STA obtains radar duration and frequency band information that are used to indicate the STA to perform radar measurement respectively from the radar duration subfield and the resource control subfield included in the target user info field.

Step 53: Send an uplink data packet to the AP, record a first sending moment of the uplink data packet, and perform radar measurement on a target object based on the radar measurement indication information to obtain a radar measurement result.

As described above, when receiving the trigger frame from the AP, the STA may identify whether the trigger frame is a wireless sensing sounding frame based on a value of a trigger type field included in a common info field in the trigger frame and a value of a WiFi sensing trigger subtype subfield. When the trigger frame from the AP is a wireless sensing sounding frame, step 53 is performed.

In this embodiment, the STA may concurrently send the uplink data packet to the AP and perform radar measurement on the target object based on the radar measurement indication information. Alternatively, the STA may perform radar measurement on the target object based on the radar measurement indication information after completing sending the uplink data packet to the AP.

In this embodiment, the uplink data packet may be a null data packet that does not carry data content, and the null data packet that does not carry data content may also be referred to as an uplink null data packet (UL NDP).

In this embodiment, the STA may serve as a monostatic radar. After the STA obtains the radar duration and the frequency band information from the wireless sensing sounding frame, the STA performs radar measurement on the target object by using the foregoing method for performing radar measurement on a target object and obtains a corresponding radar measurement result.

As described above, the radar measurement result obtained by the STA may include three forms: Before FFT, FFT info, and FFT result. Therefore, in a possible implementation, the wireless sensing sounding frame from the AP may further include an indication message used to indicate a form of the radar measurement result that needs to be obtained when the STA performs radar measurement on the target object.

In an example, refer to FIG. 6 and FIG. 7. The radar info indication subfield may further include a feedback control subfield, and the feedback control subfield may include a Before FFT control subfield, an FFT info control subfield, and an FFT result control subfield. By coordinating values of the Before FFT control subfield, the FFT info control subfield, and the FFT result control subfield in the wireless sensing sounding frame, the AP may indicate the STA to obtain a radar measurement result in a specific form. For example, if the AP needs to indicate the STA to obtain a radar measurement result in a form of Before FFT, the AP may set, to 1, a value of the Before FFT control field included in the wireless sensing sounding frame sent by the AP to the STA, and set values of the FFT info control subfield and the FFT result control subfield to 0. Correspondingly, the AP may determine a target subfield (for example, the Before FFT control field) whose value is 1 by querying the Before FFT control subfield, the FFT info control subfield, and the FFT result control subfield included in the wireless sensing sounding frame. Then, a form of the radar measurement result obtained by the STA may be a form indicated by the target subfield.

In a possible implementation, the feedback control subfield may further include a channel state information (CSI) control subfield. By coordinating a value of the CSI control subfield in the wireless sensing sounding frame, the AP may indicate whether the STA needs to obtain CSI used to sense a movement status of the target object, and to add the obtained CSI to the radar measurement result. For example, if the value of the CSI control subfield included in the wireless sensing sounding frame received by the STA is 1, the STA needs to obtain CSI used to sense a movement status of the target object, and to add the obtained CSI to the radar measurement result.

Step 55: Receive a downlink data packet from the AP and record a first receiving moment of the downlink data packet.

In this embodiment, the downlink data packet may be a null data packet that does not carry data content, and the null data packet that does not carry data content may also be referred to as a downlink null data packet (DL NDP).

The STA may further receive a null data packet announcement (NDPA) from the AP before step 55. The NDPA is used to reserve a downlink network resource of the STA, so that the STA can receive a DL NDP sent by the AP to the STA.

Step 57: Send the first sending moment, the first receiving moment and the radar measurement result to the AP.

In this embodiment, the STA may send the first sending moment and the first receiving moment to the AP under coordination of the AP by using an LMR frame and sends the radar measurement result to the AP under coordination of the AP by using a wireless sensing data frame. Alternatively, the STA may send the first sending moment, the first receiving moment, and the radar measurement result to the AP under coordination of the AP by using a wireless sensing data (WiFi sensing data) frame.

In a possible implementation, the STA may send a WiFi sensing data frame including the first sending moment, the first receiving moment, and the radar measurement result to the AP in response to a WiFi sensing report frame sent by the AP to the STA.

In an example, the WiFi sensing report frame may have a structure shown in FIG. 8. As shown in FIG. 8, the WiFi sensing report frame may include a MAC header field, a common info field, one or more user info fields, a padding field, and an FCS field. The common info field may include at least a trigger type field, a reserved field, and a trigger dependent common info field. The trigger dependent common info field may include a WiFi sensing trigger subtype subfield, a reserved subfield, and a feedback control subfield. The feedback control subfield may include at least an FTM feedback control subfield. By coordinating a value of the FTM feedback control subfield in the WiFi sensing report frame, the AP may indicate whether the STA needs to feed back a WiFi sensing data frame including the first sending moment, the first receiving moment, and the radar measurement result to the AP. For example, after identifying the trigger frame from the AP as the WiFi sensing report frame, the STA may further query the value of the FTM feedback control subfield included in the WiFi sensing report frame. If the value of the FTM feedback control subfield is first indication information (for example, is 1), the STA feeds back a WiFi sensing data frame including the first sending moment, the first receiving moment, and the radar measurement result to the AP. On the contrary, if the value of the FTM feedback control subfield is not the first indication information (for example, is 0), the STA may feedback a WiFi sensing data frame including the radar measurement result to the AP.

In an example, a feedback control subfield included in the WiFi sensing report frame may further include a CSI subfield, a Before FFT control subfield, an FFT info control subfield, and an FFT result control subfield. Functions of the CSI control subfield, the Before FFT control subfield, the FFT info control subfield, and the FFT result control subfield are the same as the functions of the CSI control subfield, the Before FFT control subfield, the FFT info control subfield, and the FFT result control subfield included in the WiFi sensing sounding frame shown in FIG. 6 or FIG. 7. Details are not described herein again.

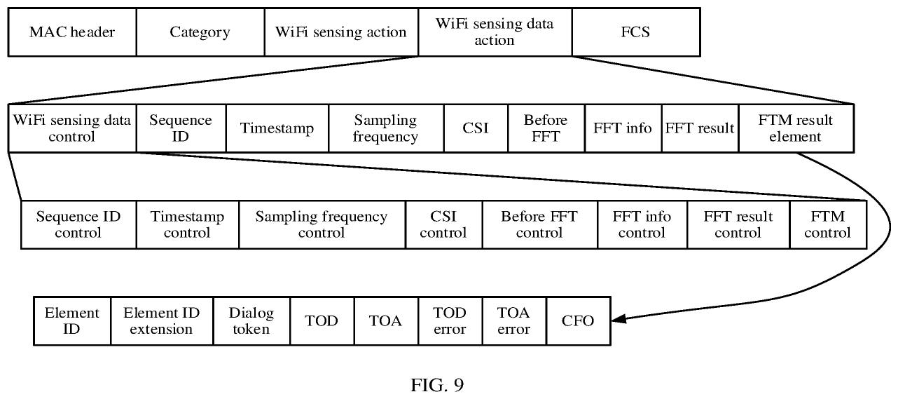

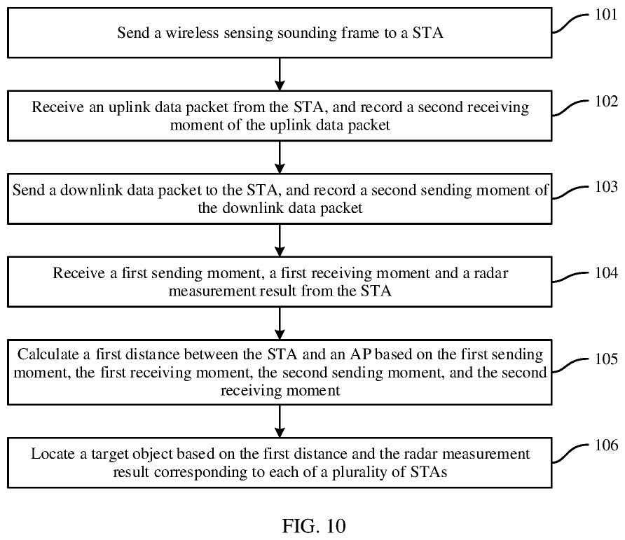

In an example, the WiFi sensing data frame may include a structure shown in FIG. 9. As shown in FIG. 9, when an AP communicates with a STA based on the IEEE802.11 protocol, a WiFi sensing data frame sent by the STA to the AP may include a MAC header field, a category field, a wireless sensing action (WiFi sensing action) field, a wireless sensing data action (WiFi sensing data action) field, and an FCS field as shown in FIG. 9. The WiFi sensing data action field may include a wireless sensing data control (WiFi sensing data control) field, a sequence identification (sequence ID) field, a timestamp field, a sampling frequency field, a CSI field, a Before FFT field, an FFT info field, an FFT result field, and an FTM result element field. The WiFi sensing data control field may include a sequence identification control (sequence ID control) subfield, a timestamp control subfield, a sampling frequency control subfield, a CSI control subfield, a Before FFT control subfield, an FFT info control subfield, an FFT result control subfield, and an FTM control subfield. The FTM result element field may include an element identification (element ID) subfield, an element identification extension (element ID extension) subfield, a dialog token subfield, a time of departure (TOD) subfield, a time of arrival (TOA) subfield, a time of departure error (TOD error) subfield, a time of arrival error (TOA error) subfield, and a carrier frequency offset (CFO) subfield.

By coordinating a value of the FTM control subfield included in the WiFi sensing data frame, the STA may indicate to the AP whether the WiFi sensing data frame includes the first receiving moment and the first sending moment that are recorded by the STA when the AP performs FTM on the STA. For example, the AP may first query the value of the FTM control subfield included in the WiFi sensing data frame. The value of the FTM control subfield is second indication information (for example, is 1), indicating that the WiFi sensing data frame includes an FTM result element field. The AP may obtain, from the FTM result element field under an indication of the second indication information, the first receiving moment and the first sending moment that are recorded by the STA. The first receiving moment may be stored in a TOA subfield, and the first sending moment may be located in a TOD subfield.

On the contrary, the AP finds that the value of the FTM control subfield included in the WiFi sensing data frame is not the second indication information (for example, is 0), indicating that the WiFi sensing data frame does not include an FTM result element field, or indicating that an FTM result element field included in the WiFi sensing data frame does not include the first receiving moment and the first sending moment that are recorded by the STA when the AP performs FTM on the STA.

Correspondingly, when the WiFi sensing data frame fed back by the STA to the AP does not include the first sending moment and the first receiving moment, in another possible implementation, the STA may send an LMR frame including the first sending moment and the first receiving moment to the AP in response to a ranging report (ranging report) frame from the AP.

Corresponding to the method for assisting in locating a target object shown in FIG. 5, an embodiment further provides a method for locating a target object. The method is for each STA of a plurality of STAs, and the method is applied to an AP. As shown in FIG. 10, the method for locating a target object may include at least the following step 101 to step 106.

Step 101: Send a wireless sensing sounding frame to a STA.

The wireless sensing sounding frame includes radar measurement indication information used to indicate the STA to perform radar measurement on a target object.

A plurality of STAs are STAs that are determined by the AP after the AP polls all STAs connected to the AP and that can be configured to perform radar measurement on the target object as radars under coordination of the AP.

In a possible implementation, the AP may separately send wireless sensing sounding frames to the plurality of STAs at different moments. The wireless sensing sounding frames separately received by the plurality of STAs each may have a structure shown in FIG. 6, and the wireless sensing sounding frames separately received by the plurality of STAs may include same radar measurement indication information.

In another possible implementation, the AP may send a wireless sensing sounding frame to the plurality of STAs in a multicast or broadcast manner. The wireless sensing sounding frame may have a structure shown in FIG. 7. Radar measurement indication information included in a plurality of user information fields in the wireless sensing sounding frame each includes different frequency band information. In this case, the plurality of STAs each may send a first radar signal and/or receive a second radar signal on different frequency bands in a same time period. Therefore, this helps to reduce time overheads required in an information exchange process between the AP and the plurality of STAs.

In a possible implementation, when the AP sends the wireless sensing sounding frame to the plurality of STAs in the multicast or broadcast manner, for each of the plurality of user information fields included in the wireless sensing sounding frame, the user information field may further include channel information used to indicate a STA corresponding to the user information field to send an uplink data packet Channel information included in each of the plurality of user information fields is different, so that the plurality of STAs may send uplink data packets to the AP on different channels in a same time period. Therefore, this can further reduce the time overheads required in the information exchange process between the AP and the plurality of STAs.

Step 102: Receive an uplink data packet from the STA and record a second receiving moment of the uplink data packet.

In a possible implementation, when the AP sends the wireless sensing sounding frame to the plurality of STAs in the multicast or broadcast manner, the AP may concurrently receive uplink data packets on a plurality of channels based on channel information included in each of the plurality of user info fields in the wireless sensing sounding frame, where the uplink data packets are separately sent by the plurality of STAs.

Step 103: Send a downlink data packet to the STA and record a second sending moment of the downlink data packet.

Before step 103, the AP may further send an NDPA to each STA in a unicast, multicast, or broadcast manner, and reserve a downlink network resource of each STA, so that each STA can receive a DL NDP sent by the AP to the STA.

In a possible implementation, the AP may separately send a downlink data packet to the plurality of STAs at different moments.

In another possible implementation, the AP may send a downlink data packet to the plurality of STAs in the multicast or broadcast manner. Therefore, this can further reduce the time overheads required in the information exchange process between the AP and the plurality of STAs.

Step 104: Receive a first sending moment, a first receiving moment and a radar measurement result from the STA.

The first sending moment is a corresponding moment at which the STA sends the uplink data packet, the first receiving moment is a corresponding moment at which the STA receives the downlink data packet, and the radar measurement result is a radar measurement result obtained when the STA performs radar measurement on a target object based on the radar measurement indication information.

In a possible implementation, the AP may send a WiFi sensing report frame to the plurality of STAs in the multicast or broadcast manner, so that the plurality of STAs send WiFi sensing data frames to the AP on different frequency bands/channels in a same time period. For one STA, a frequency band/channel used by the STA to send a WiFi sensing data frame to the AP may be a frequency band indicated by frequency band information included in radar measurement indication information obtained by the STA, or a channel indicated by channel information included in a user info field corresponding to the STA. Therefore, this can further reduce the time overheads required in the information exchange process between the AP and the plurality of STAs.

Step 105: Calculate a first distance between the STA and the AP based on the first sending moment, the first receiving moment, the second sending moment, and the second receiving moment.

Step 106: Locate the target object based on the first distance and the radar measurement result corresponding to each of the plurality of STAs.

As described above, in step 106, for each STA of the plurality of STAs, the AP may determine location information of the STA based on the first distance between the STA and the AP, location information of the AP in a coordinate system, and an angle of arrival of an electromagnetic wave from the STA or an angle of arrival of an electromagnetic wave sent by the AP to the STA. For the angle of arrival of the electromagnetic wave from the STA, as described above, the AP may measure the angle of arrival by using a phase-based angle estimation method with reference to at least the radar coordinate system shown in FIG. 3 and the example of the phase-based angle estimation method shown in FIG. 4. Then, the AP may locate the target object based on location information and radar measurement results of the plurality of STAs.

For ease of description and understanding of the solutions, the following describes an information exchange process between an AP and a plurality of STAs by using an example in which the plurality of STAs include a STA 1, a STA 2, a STA 3, and a STA 4.

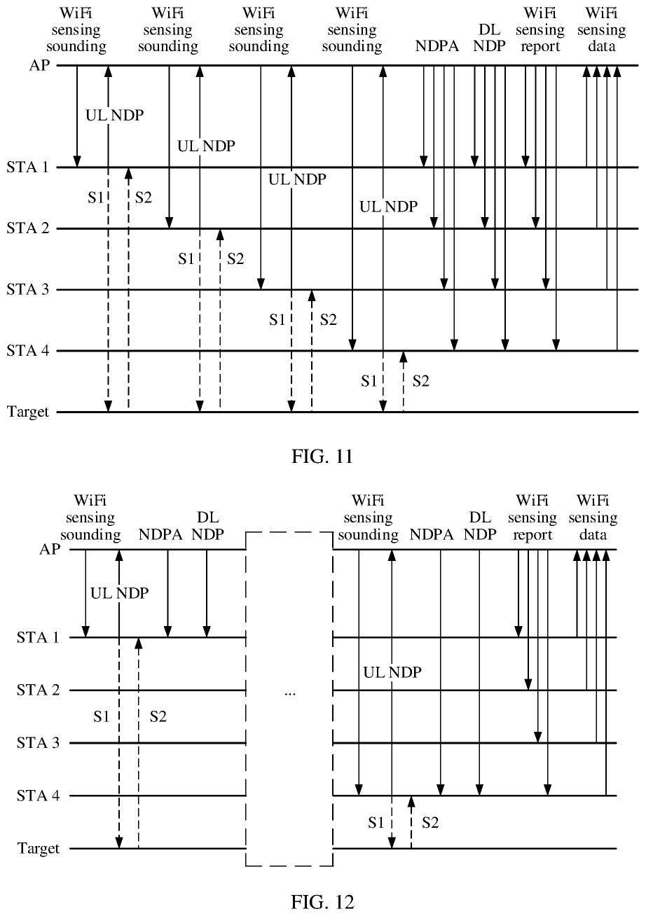

In an example, first, the AP may select an unselected STA from the plurality of STAs (STA 1, STA 2, STA 3, and STA 4), and send a WiFi sensing sounding frame to the selected STA as shown in FIG. 11. In this way, the STA selected by the AP sends a UL NDP to the AP, sends a first radar signal S1 to a target object (Target), and receives a second radar signal S2 formed through reflecting the sent S1 by the target object.

After receiving the UL NDP sent by the selected STA to the AP, the AP may reselect an unselected STA from the plurality of STAs and perform a process similar to the foregoing process, to separately send a WiFi sensing sounding frame to the plurality of STAs at different time points.

When there is no unselected STA in the plurality of STAs, the AP may send an NDPA to the plurality of STAs in a unicast, multicast, or broadcast manner, and indicate, by using the NDPA, the plurality of STAs to receive a DL NDP to be sent by the AP.

Then, the AP separately sends the DL NDP to the plurality of STAs in the unicast, multicast, or broadcast manner.

Finally, the AP sends a WiFi sensing report frame to the plurality of STAs in the unicast, multicast, or broadcast manner, so that the plurality of STAs separately send a WiFi sensing data frame to the AP.

In another example, first, the AP may select an unselected STA from the plurality of STAs (STA 1, STA 2, STA 3, and STA 4), and send a WiFi sensing sounding frame to the selected STA as shown in FIG. 12. In this way, the STA selected by the AP sends a UL NDP to the AP, sends a first radar signal S1 to a target object (Target), and receives a second radar signal S2 formed through reflecting the sent S1 by the target object.

Then, the AP sends an NDPA to the selected STA in a unicast manner, and indicate, by using the NDPA, the selected STA to receive a DL NDP to be sent by the AP.

Then, the AP sends the DL NDP to the selected STA in the unicast manner.

Next, the AP may reselect an unselected STA from the plurality of STAs and perform a process similar to the foregoing process.

When there is no unselected STA in the plurality of STAs, the AP sends a WiFi sensing report frame to the plurality of STAs in a unicast, multicast, or broadcast manner, so that the plurality of STAs separately send a WiFi sensing data frame to the AP.

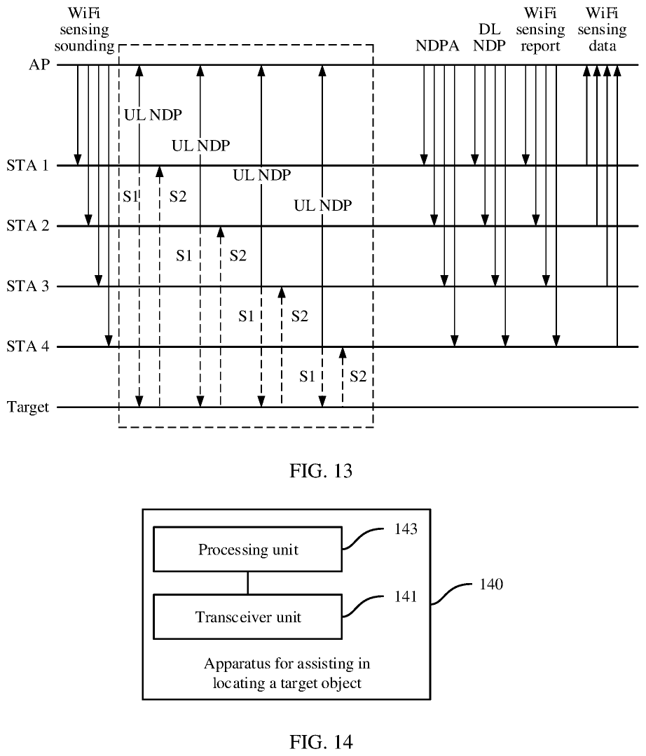

In another example, first, the AP may send a WiFi sensing sounding frame to the plurality of STAs (STA 1, STA 2, STA 3, STA 4) in a multicast or broadcast manner as shown in FIG. 13, so that the plurality of STAs each send a UL NDP to the AP on different channels in a same time period, and each send a first radar signal S1 and receive a second radar signal S2 on different frequency bands in a same time period.

Then, the AP may send an NDPA to the plurality of STAs in a unicast, multicast, or broadcast manner, and indicate, by using the NDPA, the plurality of STAs to receive a DL NDP to be sent by the AP.

Next, the AP may separately send the DL NDP to the plurality of STAs in the unicast, multicast, or broadcast manner.

Finally, the AP may send a WiFi sensing report frame to the plurality of STAs in the unicast, multicast, or broadcast manner, so that the plurality of STAs separately send a WiFi sensing data frame to the AP.

Based on a same concept as that in the foregoing method embodiments, as shown in FIG. 14, an embodiment further provides an apparatus for assisting in locating a target object, applied to a STA. The apparatus 140 includes:
a transceiver unit 141, configured to: receive a wireless sensing sounding frame from an AP, where the wireless sensing sounding frame includes radar measurement indication information; send an uplink data packet to the AP; and receive a downlink data packet from the AP; and
a processing unit 143, configured to: record a first sending moment of the uplink data packet, record a first receiving moment of the downlink data packet, and perform radar measurement on a target object based on the radar measurement indication information to obtain a radar measurement result, where
the transceiver unit is further configured to send the first sending moment, the first receiving moment and the radar measurement result to the AP.

In a possible implementation,
the processing unit 143 is configured to: trigger, based on the radar measurement indication information, the transceiver unit to send a first radar signal; and trigger, based on the radar measurement indication information, the transceiver unit to receive a second radar signal, where the second radar signal is formed through reflecting the first radar signal by the target object; and
the processing unit 141 is configured to determine the radar measurement result based on a first start moment at which the transceiver unit sends the first radar signal, a second start moment at which the transceiver unit receives the second radar signal, the first radar signal, and the second radar signal.

In a possible implementation, a trigger dependent common information field in the wireless sensing sounding frame includes a radar information indication subfield, and the radar information indication subfield includes the radar measurement indication information.

In a possible implementation, one user information field in the wireless sensing sounding frame includes an application identification field and a trigger dependent user information field, where the application identification field includes an identifier of the STA, the trigger dependent user information field includes a radar information indication subfield, and the radar information indication subfield includes the radar measurement indication information.

In a possible implementation,
the radar information indication subfield includes a radar duration subfield and a resource control subfield; and
the radar measurement indication information includes radar duration and frequency band information, where the radar duration subfield includes the radar duration, and the resource control subfield includes the frequency band information.

In a possible implementation, the processing unit 143 is configured to: in response to a wireless sensing report frame sent by the AP to the STA, trigger the transceiver unit to send a wireless sensing data frame to the AP, where the wireless sensing data frame includes the first sending moment, the first receiving moment and the radar measurement result.

In a possible implementation,
a trigger dependent common information field in the wireless sensing report frame includes a feedback control subfield; and
the feedback control subfield includes at least a fine time measurement FTM feedback control subfield, the FTM feedback control subfield includes first indication information, and the first indication information is used to indicate the STA to send the wireless sensing data frame to the AP.

In a possible implementation,
a wireless sensing data action field in the wireless sensing data frame includes an FTM result element field; and
the first receiving moment and the first sending moment are included in the FTM result element field.

In a possible implementation, the wireless sensing data action field in the wireless sensing data frame further includes a wireless sensing data control field, and the wireless sensing data control field includes an FTM control subfield, where the FTM control subfield includes second indication information, and the second indication information is used to indicate the AP to obtain the first receiving moment and the first sending moment from the FTM result element field.

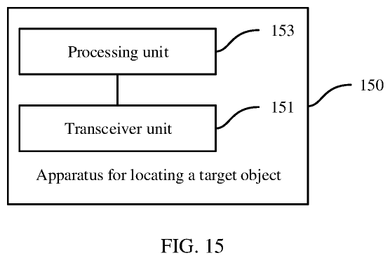

Based on a same concept as that in the foregoing method embodiments, as shown in FIG. 15, an embodiment further provides an apparatus for locating a target object, applied to an AP. The apparatus 150 includes:
a transceiver unit 151, configured to: for each STA of a plurality of STAs, send a wireless sensing sounding frame to the STA, where the wireless sensing sounding frame includes radar measurement indication information; receive an uplink data packet from the STA; send a downlink data packet to the STA; and receive a first sending moment, a first receiving moment and a radar measurement result from the STA, where the first sending moment is a corresponding moment at which the STA sends the uplink data packet, the first receiving moment is a corresponding moment at which the STA receives the downlink data packet, and the radar measurement result is a radar measurement result obtained when the STA performs radar measurement on a target object based on the radar measurement indication information; and
a processing unit 153, configured to: record a second receiving moment of the uplink data packet; record a second sending moment of the downlink data packet; calculate a first distance between the STA and the AP based on the first sending moment, the first receiving moment, the second sending moment, and the second receiving moment; and locate the target object based on the first distance and the radar measurement result corresponding to each of the plurality of STAs.

In a possible implementation, the processing unit 153 is configured to trigger the transceiver unit 151 to send the wireless sensing sounding frame to the plurality of STAs in a multicast or broadcast manner, where a plurality of user information fields in the wireless sensing sounding frame are in a one-to-one correspondence with the plurality of STAs, the user information field includes an identifier of a corresponding STA and the radar measurement indication information used to indicate the corresponding STA to perform radar measurement, and the radar measurement indication information included in the plurality of user information fields each includes different frequency band information.

In a possible implementation,
the user information field further includes channel information used to indicate the corresponding STA to send the uplink data packet, and the channel information included in each of the plurality of user information fields is different; and
the processing unit 153 is configured to trigger, based on the channel information included in each user information field, the transceiver unit to receive the uplink data packet from each of the plurality of STAs.

In a possible implementation, the processing unit 153 is configured to trigger the transceiver unit 151 to send the downlink data packet to the plurality of STAs in a multicast or broadcast manner.

An embodiment further provides a computer-readable storage medium, configured to store instructions. When the instructions are executed by a processor of a STA, the STA is enabled to implement the method for assisting in locating a target object according to any embodiment.

An embodiment further provides a computer-readable storage medium, configured to store instructions. When the instructions are executed by a processor of an AP, the AP is enabled to implement the method for locating a target object according to any embodiment of this application.

An embodiment further provides a STA, including a memory and a processor. The memory stores executable code, and when the processor executes the executable code, the method for assisting in locating a target object according to any embodiment of this application is implemented.

An embodiment further provides an AP, including a memory and a processor. The memory stores executable code, and when the processor executes the executable code, the method for locating a target object according to any embodiment is implemented.

An embodiment further provides a computer program product. The computer program product includes computer program code, and when the computer program code is run on a computer, the computer is enabled to perform the method for assisting in locating a target object according to any embodiment.

An embodiment further provides a computer program product. The computer program product includes computer program code, and when the computer program code is run on a computer, the computer is enabled to perform the method for locating a target object according to any embodiment.

An embodiment further provides a communication apparatus, and the communication apparatus has functions of the STA in the foregoing aspects. The functions of the STA may be implemented by using hardware or may be implemented by using hardware executing corresponding software. The hardware or the software includes one or more units corresponding to the foregoing functions.

An embodiment further provides a communication apparatus, and the communication apparatus has functions of the AP in the foregoing aspects. The functions of the AP may be implemented by using hardware or may be implemented by using hardware executing corresponding software. The hardware or the software includes one or more units corresponding to the foregoing functions.

An embodiment further provides a communication apparatus. The communication apparatus may be the STA in the foregoing aspects, or may be a chip disposed in the STA. The communication apparatus includes a memory, a communication interface, and a processor. The memory is configured to store a computer program or instructions. The processor is coupled to the memory and the communication interface. When the processor executes the computer program or the instructions, the communication apparatus is enabled to perform the method for assisting in locating a target object according to any embodiment.

An embodiment further provides a communication apparatus. The communication apparatus may be the AP in the foregoing aspects, or may be a chip disposed in the AP. The communication apparatus includes a memory, a communication interface, and a processor. The memory is configured to store a computer program or instructions. The processor is coupled to the memory and the communication interface. When the processor executes the computer program or the instructions, the communication apparatus is enabled to perform the method for locating a target object according to any embodiment.

An embodiment further provides a chip system. The chip system includes a processor, configured for functions of the STA in any embodiment, for example, to receive or process data and/or information in the method for assisting in locating a target object according to any embodiment. The chip system may further include a memory. The memory is configured to store program instructions and/or data. The chip system may include a chip or may include a chip and another discrete device.

An embodiment further provides a chip system. The chip system includes a processor, configured to implement functions of the AP in any embodiment, for example, receive or process data and/or information in the method for locating a target object according to any embodiment. The chip system may further include a memory. The memory is configured to store program instructions and/or data. The chip system may include a chip or may include a chip and another discrete device.

A person of ordinary skill in the art may be aware that, in combination with the examples described in the embodiments, units and algorithm steps may be implemented by electronic hardware or a combination of computer software and electronic hardware. Whether these functions are performed in hardware or software depends on applications and design constraints of the solutions. A person skilled in the art may use different methods to implement the described functions for each particular application, but it should not be considered that the implementation goes beyond the scope of the embodiments.

It should be understood that sequence numbers of the foregoing processes do not mean execution sequences in the various embodiments. The execution sequences of the processes should be determined according to functions and internal logic of the processes and should not be construed as any limitation on the implementation processes of the embodiments.

It may be clearly understood by a person skilled in the art that, for the purpose of convenient and brief description, for a detailed working process of the foregoing network device, refer to a corresponding process in the foregoing method embodiments. Details are not described herein again.

It may be understood that the described apparatus embodiments are examples. For example, the module/unit division is merely logical function division and may be another division manner during actual implementation. For example, a plurality of units or components may be combined or integrated into another system, or some features may be ignored or not performed. In addition, the displayed or discussed mutual coupling or direct coupling or communication connections may be implemented through some interfaces. The indirect coupling or communication connections between the apparatuses or units may be implemented in electronic, mechanical, or other forms.

The foregoing descriptions are merely implementations of the embodiments, but are not intended as limiting the scope of the embodiments. Any variation or replacement readily figured out by a person skilled in the art within the scope in the embodiments shall fall within the scope of the embodiments.

Finally, it should be noted that the foregoing embodiments are merely intended for describing the solutions of the embodiments, but are not limiting. Although described in detail with reference to the foregoing embodiments, a person of ordinary skill in the art may still make modifications to the solutions provided in the foregoing embodiments or make equivalent replacements to some features thereof, without departing from the spirit and scope of the solutions of the embodiments.

What is claimed is:

1. A method applied to a station (STA), the method comprising:
receiving a wireless sensing sounding frame from an access point (AP), wherein the wireless sensing sounding frame comprises radar measurement indication information;
sending an uplink data packet to the AP and recording a first sending moment of the uplink data packet;
performing radar measurement on a target object based on the radar measurement indication information to obtain a radar measurement result;
receiving a downlink data packet from the AP;
recording a first receiving moment of the downlink data packet; and
sending the first sending moment, the first receiving moment and the radar measurement result to the AP.

2. The method according to claim 1, wherein performing the radar measurement on the target object based on the radar measurement indication information to obtain the radar measurement result further comprises:
sending a first radar signal based on the radar measurement indication information;
receiving a second radar signal based on the radar measurement indication information, wherein the second radar signal is formed through reflecting the first radar signal by the target object; and
determining the radar measurement result based on a first start moment at which the first radar signal is sent, a second start moment at which the second radar signal is received, the first radar signal, and the second radar signal.

3. The method according to claim 1, wherein
a trigger dependent common information field in the wireless sensing sounding frame comprises a radar information indication subfield, and the radar information indication subfield comprises the radar measurement indication information; or
one user information field in the wireless sensing sounding frame comprises an application identification field and a trigger dependent user information field, wherein the application identification field comprises an identifier of the STA, the trigger dependent user information field comprises a radar information indication subfield, and the radar information indication subfield comprises the radar measurement indication information.

4. The method according to claim 3, wherein
the radar information indication subfield comprises a radar duration subfield and a resource control subfield; and
the radar measurement indication information comprises radar duration and frequency band information, wherein the radar duration subfield comprises the radar duration, and the resource control subfield comprises the frequency band information.

5. The method according to claim 1, wherein
sending the first sending moment, the first receiving moment and the radar measurement result to the AP further comprises:
sending a wireless sensing data frame to the AP in response to a wireless sensing report frame sent by the AP to the STA, wherein the wireless sensing data frame comprises the first sending moment, the first receiving moment and the radar measurement result.

6. The method according to claim 5, wherein
a trigger dependent common information field in the wireless sensing report frame comprises a feedback control subfield; and
the feedback control subfield comprises at least a fine time measurement (FTM) feedback control subfield, the FTM feedback control subfield comprises first indication information, and the first indication information is used to indicate the STA to send the wireless sensing data frame to the AP.

7. The method according to claim 5, wherein
a wireless sensing data action field in the wireless sensing data frame comprises an FTM result element field; and
the first receiving moment and the first sending moment are comprised in the FTM result element field.

8. The method according to claim 7, wherein
the wireless sensing data action field in the wireless sensing data frame further comprises a wireless sensing data control field, and the wireless sensing data control field comprises an FTM control subfield, wherein the FTM control subfield comprises second indication information, and the second indication information is used to indicate the AP to obtain the first receiving moment and the first sending moment from the FTM result element field.

9. An apparatus, comprising a memory and a processor, wherein the memory stores executable instructions that when executed by the processor, cause the apparatus to:
receive a wireless sensing sounding frame from an access point (AP), wherein the wireless sensing sounding frame comprises radar measurement indication information;
send an uplink data packet to the AP, record a first sending moment of the uplink data packet, and perform radar measurement on a target object based on the radar measurement indication information to obtain a radar measurement result;
receive a downlink data packet from the AP, and record a first receiving moment of the downlink data packet; and
send the first sending moment, the first receiving moment and the radar measurement result to the AP.

10. The apparatus according to claim 9, wherein when the executable instructions are executed by the processor, further cause the apparatus to:
send a first radar signal based on the radar measurement indication information, and receive a second radar signal based on the radar measurement indication information, wherein the second radar signal is formed through reflecting the first radar signal by the target object; and
determine the radar measurement result based on a first start moment at which the first radar signal is sent, a second start moment at which the second radar signal is received, the first radar signal, and the second radar signal.

11. The apparatus according to claim 9, wherein
a trigger dependent common information field in the wireless sensing sounding frame comprises a radar information indication subfield, and the radar information indication subfield comprises the radar measurement indication information; or
one user information field in the wireless sensing sounding frame comprises an application identification field and a trigger dependent user information field, wherein the application identification field comprises an identifier of a station (STA), the trigger dependent user information field comprises a radar information indication subfield, and the radar information indication subfield comprises the radar measurement indication information.

12. The apparatus according to claim 11, wherein
the radar information indication subfield comprises a radar duration subfield and a resource control subfield; and
the radar measurement indication information comprises radar duration and frequency band information, wherein the radar duration subfield comprises the radar duration, and the resource control subfield comprises the frequency band information.

13. The apparatus according to claim 9, wherein when the executable instructions are executed by the processor, further cause the apparatus to:
send a wireless sensing data frame to the AP in response to a wireless sensing report frame sent by the AP to the apparatus, wherein the wireless sensing data frame comprises the first sending moment, the first receiving moment and the radar measurement result.

14. The apparatus according to claim 13, wherein
a trigger dependent common information field in the wireless sensing report frame comprises a feedback control subfield; and
the feedback control subfield comprises at least a fine time measurement (FTM) feedback control subfield, the FTM feedback control subfield comprises first indication information, and the first indication information is used to indicate the apparatus to send the wireless sensing data frame to the AP.

15. The apparatus according to claim 13, wherein
a wireless sensing data action field in the wireless sensing data frame comprises an FTM result element field; and
the first receiving moment and the first sending moment are comprised in the FTM result element field.

16. The apparatus according to claim 15, wherein
the wireless sensing data action field in the wireless sensing data frame further comprises a wireless sensing data control field, and the wireless sensing data control field comprises an FTM control subfield, wherein the FTM control subfield comprises second indication information, and the second indication information is used to indicate the AP to obtain the first receiving moment and the first sending moment from the FTM result element field.

17. A non-transitory computer readable storage medium, comprising a program stored thereon which, when executed by a processor of a station (STA), causes the STA to:
receive a wireless sensing sounding frame from an access point (AP), wherein the wireless sensing sounding frame comprises radar measurement indication information;
send an uplink data packet to the AP, record a first sending moment of the uplink data packet;
perform radar measurement on a target object based on the radar measurement indication information to obtain a radar measurement result;
receive a downlink data packet from the AP;
record a first receiving moment of the downlink data packet; and
send the first sending moment, the first receiving moment and the radar measurement result to the AP.

18. The non-transitory computer readable storage medium according to claim 17, wherein when the program is executed by the processor of the STA, further causes the STA to:
send a first radar signal based on the radar measurement indication information, and receive a second radar signal based on the radar measurement indication information, wherein the second radar signal is formed through reflecting the first radar signal by the target object; and
determine the radar measurement result based on a first start moment at which the first radar signal is sent, a second start moment at which the second radar signal is received, the first radar signal, and the second radar signal.

19. The non-transitory computer readable storage medium according to claim 17, wherein
a trigger dependent common information field in the wireless sensing sounding frame comprises a radar information indication subfield, and the radar information indication subfield comprises the radar measurement indication information; or
one user information field in the wireless sensing sounding frame comprises an application identification field and a trigger dependent user information field, wherein the application identification field comprises an identifier of the STA, the trigger dependent user information field comprises a radar information indication subfield, and the radar information indication subfield comprises the radar measurement indication information.

20. The non-transitory computer readable storage medium according to claim 19, wherein
the radar information indication subfield comprises a radar duration subfield and a resource control subfield; and
the radar measurement indication information comprises radar duration and frequency band information, wherein the radar duration subfield comprises the radar duration, and the resource control subfield comprises the frequency band information.
